(19) United States
(12) Patent Application Publication
(10) Pub. No.: US 2018/0018648 A1
(43) Pub. Date: Jan. 18, 2018

(54) SYSTEMS AND METHODS FOR MANAGING USER ACCOUNTS USING A DIRECTORY KIOSK SYSTEM

(71) Applicant: MasterCard International Incorporated, Purchase, NY (US)

(72) Inventor: Richard Unnerstall, O'Fallon, MO (US)

(21) Appl. No.: 15/212,533

(22) Filed: Jul. 18, 2016

(51) Int. Cl. G06Q 20/18; H04L 29/06; G06Q 20/20

(52) U.S. Cl. CPC G06Q 20/18; G06Q 20/206; H04L 63/102

(57) ABSTRACT

Embodiments of the disclosure enable a plurality of user accounts to be managed using a directory kiosk system. The directory kiosk system includes a controlled apparatus including a lock mechanism selectively configurable between a restricted configuration and an accessible configuration, and a control system that identifies tenant data associated with a tenant, determines a payment status associated with the tenant based on the tenant data, generates a first indication instruction based on the payment status to present a first indication associated with the payment status at the presentation device, determines whether the payment status satisfies a predetermined accessibility threshold, and, on condition that the predetermined accessibility threshold is satisfied, generates an accessibility instruction to selectively configure the lock mechanism in the accessible configuration. Aspects of the disclosure provide for using a directory kiosk system to process one or more transactions for one or more users.

### FIELD OF THE DISCLOSURE

The subject matter described herein relates generally to directory kiosks and, more specifically, to a smart directory kiosk system that allows one or more users to facilitate managing one or more user accounts.

### BACKGROUND

Directory kiosks may be used to present information to a user (e.g., consumer). Some directory kiosks are located in a large, high-traffic area, such as a shopping mall or office building, to enable a consumer to utilize the directory kiosk to locate one or more merchants in the shopping mall or office building. At least some known directory kiosks, however, are limited in functionality. For example, the information presented at a directory kiosk may be limited to a static map or directory. Moreover, the information presented at the directory kiosk may be directed to only one class of users (e.g., consumers). While another class of users (e.g., merchants) may utilize the directory kiosk to present information to its consumers, the information is not primarily directed to merchants, who may be familiar with the information presented at the directory kiosk.

### SUMMARY

Embodiments of the disclosure enable a directory kiosk system to manage a plurality of user accounts. The directory kiosk system includes a housing, a presentation device coupled to the housing, a controlled apparatus including a lock mechanism selectively configurable between a restricted configuration and an accessible configuration, and a control system that identifies tenant data associated with a tenant, determines a payment status associated with the tenant based on the tenant data, generates a first indication instruction based on the payment status to present a first indication associated with the payment status at the presentation device, determines whether the payment status satisfies a predetermined accessibility threshold, and, on condition that the predetermined accessibility threshold is satisfied, generates an accessibility instruction to selectively configure the lock mechanism in the accessible configuration.

In another aspect, one or more computer storage media embodied with instructions executable by one or more processors is provided for managing a plurality of user accounts associated with a directory kiosk system. The one or more computer storage media include a manager component that selects a tenant associated with tenant data, an indicator component that determines a payment status associated with the first based on the tenant data and generates a first indication instruction based on the payment status for presenting, at a presentation device, a first indication associated with the payment status, and a security component that determines whether a predetermined accessibility threshold is satisfied and generates an accessibility instruction based on whether the predetermined accessibility threshold is satisfied for controlling access to an area associated with the tenant in a controlled environment.

In yet another aspect, a computer-implemented method is provided for managing a plurality of user accounts associated with a directory kiosk system. The computer-implemented method includes identifying tenant data associated with a tenant, determining a payment status associated with the tenant based on the tenant data, presenting, at a presentation device, a first indication associated with the payment status, determining whether the payment status satisfies a predetermined accessibility threshold, and, on condition that the predetermined accessibility threshold is satisfied, configuring a lock mechanism in an accessible configuration to selectively allow access to an area associated with the tenant in a controlled environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example environment for managing tenant accounts.

FIG. 2 is a block diagram illustrating an example directory kiosk system that may be used to manage tenant accounts in an environment, such as the environment shown in FIG. 1.

FIG. 3 is a block diagram illustrating a plurality of example components of a directory kiosk system, such as the directory kiosk system shown in FIG. 2.

FIG. 4 is a block diagram illustrating an example directory kiosk system environment for managing tenant accounts.

FIG. 5 is a flowchart of an example method for managing tenant accounts using a directory kiosk system, such as the directory kiosk system shown in FIG. 2.

FIG. 6 is a detailed flowchart of an example method for managing tenant accounts, such as the method shown in FIG. 5.

FIG. 7 is a flowchart of an example method for providing a merchant service in an environment, such as the environment shown in FIG. 1.

FIG. 8 is a block diagram illustrating an example operating environment for managing tenant accounts in an environment, such as the environment shown in FIG. 1.

FIG. 9 is a block diagram illustrating an example environment for processing financial transactions in an environment, such as the environment shown in FIG. 1.

Corresponding reference characters indicate corresponding parts throughout the drawings.

### DETAILED DESCRIPTION

The subject matter described herein relates to a smart directory kiosk system that may be used to manage one or more user accounts. The smart directory kiosk system may allow, for example, a landlord to manage one or more properties, a tenant to access a tenant account, a merchant to provide one or more merchant services, and/or a consumer to be provided with a merchant service at the smart directory kiosk system. Embodiments of the disclosure may identify tenant data associated with a tenant, determine a payment status associated with the tenant based on the tenant data, present an indication associated with the payment status, determine whether a predetermined accessibility threshold is satisfied, and selectively configure a lock mechanism based on the determination of whether the predetermined accessibility threshold is satisfied.

Aspects of the disclosure provide for a computing system that processes one or more transactions in an environment including a plurality of devices coupled to each other via a network (e.g., local area network, wide area network, the Internet). In some embodiments, the smart directory kiosk system communicates with other computing systems (e.g., landlord system, merchant system, system server, and/or client device) to process one or more transactions for one or more users (e.g., landlord, tenant, merchant, and/or consumer). For example, the smart directory kiosk system may communicate with the landlord system to determine a payment status, determine whether a predetermined threshold is satisfied based on the payment status, and generate an accessibility instruction based on the determination of whether the predetermined threshold is satisfied to selectively configure a lock mechanism between a restricted configuration and an accessible configuration. In this manner, the smart directory kiosk system may be configured to to manage one or more properties.

The systems and processes described herein may be implemented using computer programming or engineering techniques including computer software, firmware, hardware or a combination or subset thereof. At least one technical problem with known kiosk systems is that they have limited functionality. For example, at least some known kiosk systems may be limited to presenting generally static information (e.g., maps, directories) that are directed to a single class of users (e.g., consumers). The embodiments described herein address at least this technical problem.

By processing one or more transactions in the manner described in this disclosure, some embodiments customize or tailor a directory kiosk system with increased functionality to improve user experience and/or user interaction performance. For example, the directory kiosk system may be configured to control access to one or more areas associated with one or more tenants (e.g., leased space and/or mailbox). In this manner, a landlord may utilize the directory kiosk system to incentivize one or more tenant actions (e.g., rent payments) by systematically restricting access to an area associated with a tenant when the tenant action is not desirably performed. In some embodiments, the subject matter described herein may facilitate improving user efficiency, improving communication between systems, and/or reducing error rate by automating the analysis and processing of one or more transactions.

The technical effect of the systems and processes described herein is achieved by performing at least one of the following operations: a) presenting a tenant identifier corresponding to a tenant; b) receiving selection data associated with a selection of the tenant identifier; c) identifying tenant data associated with the tenant; d) receiving credential data associated with a user of a directory kiosk system; e) determining whether the user is authorized to access the tenant data; f) determining a payment status associated with the tenant; g) presenting an indication associated with the payment status; h) determining whether the payment status satisfies one or more predetermined indicator thresholds; i) generating an indication instruction based on the determination of whether the payment status satisfies the one or more predetermined indicator thresholds; j) determining whether the payment status satisfies a predetermined accessibility threshold; k) selectively configuring a lock mechanism in an accessible configuration; l) generating transaction data associated with the tenant; m) determining whether to modify the payment status; n) presenting a service identifier corresponding to a merchant service associated with the tenant; o) receiving selection data associated with a selection of the service identifier; and/or p) providing the merchant service.

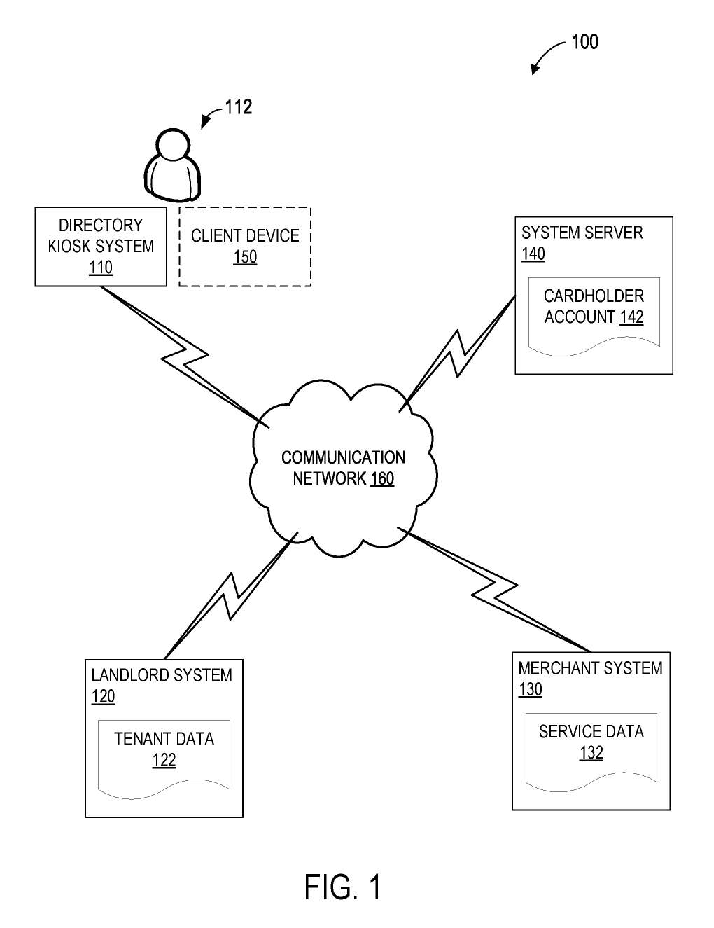

FIG. 1 is a block diagram illustrating an example environment 100 for managing one or more user accounts (e.g., properties, tenant accounts, merchant accounts, consumer account). The environment 100 includes a directory kiosk system 110 configured to provide one or more services to a user 112 of the directory kiosk system 110 (e.g., tenant, consumer). As used herein, a kiosk may be understood to refer to a system that includes a structure and a computing system, and utilizes the computing system to provide a service to a user 112 at the structure. At least a portion of the directory kiosk system 110 (e.g., structure) may be located in a high-traffic area, such as a shopping mall, a department store, an office building, a restaurant, an airport, a casino, a stadium or arena, an amusement park, a cruise ship, and the like.

The directory kiosk system 110 may allow a first user (e.g., landlord of a property) to manage one or more properties or tenant accounts associated with one or more other users (e.g., tenants). For example, the directory kiosk system 110 may communicate with a landlord system 120 associated with the landlord to access and/or obtain tenant data 122 (e.g., payment rates, payment schedules, account balances) associated with one or more tenants such that the directory kiosk system 110 is configured to receive and/or process one or more rent payments for one or more properties associated with the tenants.

Additionally or alternatively, the directory kiosk system 110 may allow a second user (e.g., merchant) to manage one or more merchant services provided at the directory kiosk system 110 to one or more other users (e.g., consumers). For example, the merchant may configure the directory kiosk system 110 to provide one or more merchant services to one or more consumers including, without limitation, locating the merchant, providing turn-by-turn directions, contacting the merchant, selling goods and/or services, scheduling appointments, and/or providing customer support. In some embodiments, the directory kiosk system 110 communicates with a merchant system 130 associated with the merchant to access and/or obtain service data 132 (e.g., geolocation data, contact information, inventory data, pricing data, scheduling data, customer support information) associated with the merchant such that the directory kiosk system 110 is configured to provide the merchant services to the consumers at the directory kiosk system 110.

In some embodiments, the merchant is a merchant-tenant. That is, in addition to utilizing the directory kiosk system 110 in a merchant capacity to configure the directory kiosk system 110 to provide the merchant services, the merchant may utilize the directory kiosk system 110 in a tenant capacity to access tenant data 122 and/or make a rent payment. Additionally or alternatively, the merchant may be a merchant-landlord and provide tenant data 122 in a landlord capacity such that the directory kiosk system 110 is configured to receive and/or process one or more rent payments for one or more properties managed by the merchant.

In some embodiments, the environment 100 includes a system server 140 that includes, stores, or has access to one or more financial or cardholder accounts 142. The system server 140 may be, for example, a financial transaction processing device configured to process one or more financial transactions (e.g., rent payment, sale of a good or service) using at least one cardholder account 142. The directory kiosk system 110 is configured to receive user input (e.g., account data, credential data) from a user 112 of the directory kiosk system 110 (e.g., tenant, consumer), generate a request for authorization for a financial transaction based on the user input, and transmit the request for authorization to the system server 140 for processing the financial transaction.

In some embodiments, the system server 140 determines whether the user 112 is authorized to access or use the cardholder account 142 before determining whether to approve or decline the request for authorization. For example, the request for authorization may include account data for identifying or selecting a cardholder account 142 from the cardholder accounts 142, and credential data for comparing with registered data associated with the cardholder account 142. In some embodiments, the request for authorization is declined if the user 112 is not authorized to access or use the cardholder account 142.

A client device 150 (e.g., mobile device, mobile telephone) associated with the user 112 may be utilized to access or utilize the directory kiosk system 110. In some embodiments, the directory kiosk system 110 communicates with the client device 150 to obtain client data that enables the directory kiosk system 110 to function as described herein. For example, client data may include account data and/or credential data that enables the directory kiosk system 110 to determine whether the user 112 is authorized to access or utilize a cardholder account 142.

The environment 100 includes one or more communication networks 160 that enable data to be transferred between a plurality of computing systems (e.g., directory kiosk system 110, landlord system 120, merchant system 130, system server 140, and/or client device 150) coupled to the communication network 160. As used herein, a computing system may be understood to mean a single computing device or a plurality of interconnected computing devices that operate together to perform a particular function. That is, each computing system may be contained within a single hardware unit or be distributed among several or many different hardware units, including in a cloud-computing environment. Example communication networks 160 include a cellular or mobile network and the Internet. Alternatively, the communication network 160 may be any communication medium that enables the environment 100 to function as described herein including, for example, a personal area network (PAN), a local area network (LAN), and/or a wide area network (WAN).

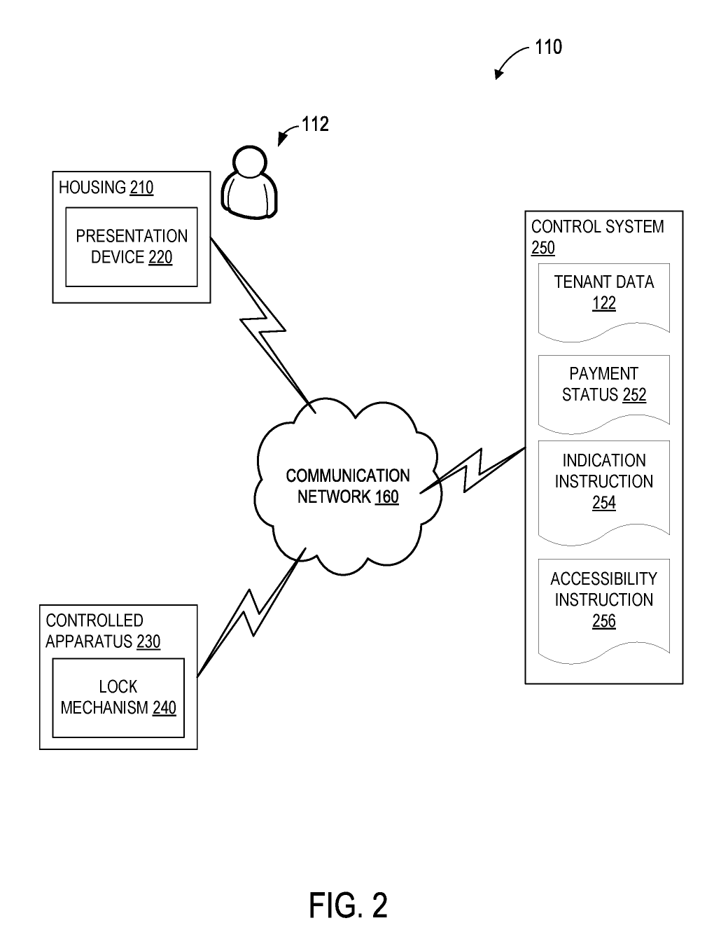

FIG. 2 is a block diagram illustrating the directory kiosk system 110 that may be used to manage at least a first tenant account associated with a first tenant. In some embodiments, the directory kiosk system 110 includes a housing 210 (e.g., structure), a presentation device 220 coupled to the housing 210, and a controlled apparatus 230 (e.g., door, gate) configured to selectively control access to an area associated with the first tenant (e.g., leased space, mailbox) in a controlled environment. For example, the controlled apparatus 230 may include, be coupled to, or be associated with a lock mechanism 240 that is configurable between an accessible configuration and a restricted configuration.

In some embodiments, the directory kiosk system 110 includes a control system 250 configured to control an operation or functionality of the directory kiosk system 110. For example, the control system 250 may transmit an instruction to another portion of the directory kiosk system 110 (e.g., presentation device 220, lock mechanism 240) to control an operation or functionality of the directory kiosk system 110. The control system 250 is configured to transmit and/or receive data via one or more communication networks 160. Additionally or alternatively, the control system 250 may be directly or integrally coupled to another portion of the directory kiosk system 110 such that the control system 250 may communicate directly with the other portion of the directory kiosk system 110.

In some embodiments, the control system 250 identifies tenant data 122 associated with the first tenant, determines a payment status 252 associated with the first tenant based on the tenant data 122, generates an indication instruction 254 based on the payment status 252 for presenting an indication associated with the payment status 252, determines whether the payment status 252 satisfies a predetermined accessibility threshold, and generates an accessibility instruction 256 based on whether the payment status 252 satisfies the predetermined accessibility threshold for selectively configuring the lock mechanism 240. For example, the lock mechanism 240 may be selectively configured in the accessible configuration when the predetermined accessibility threshold is satisfied, and selectively configured in the restricted configuration when the predetermined accessibility threshold is not satisfied. In this manner, the control system 250 may be utilized to selectively configure the lock mechanism 240 between the accessible configuration and the restricted configuration.

While the lock mechanism 240 is in the accessible configuration, a user 112 (e.g., first tenant) may unilaterally affect the operation or functionality of the lock mechanism 240. That is, the first tenant may selectively control access to the area by locking or unlocking the lock mechanism 240 when the lock mechanism 240 is in the accessible configuration. On the other hand, when the lock mechanism 240 is in the restricted configuration, use of the lock mechanism 240 is at least partially restricted such that the user may not unilaterally affect the operation or functionality of the lock mechanism 240.

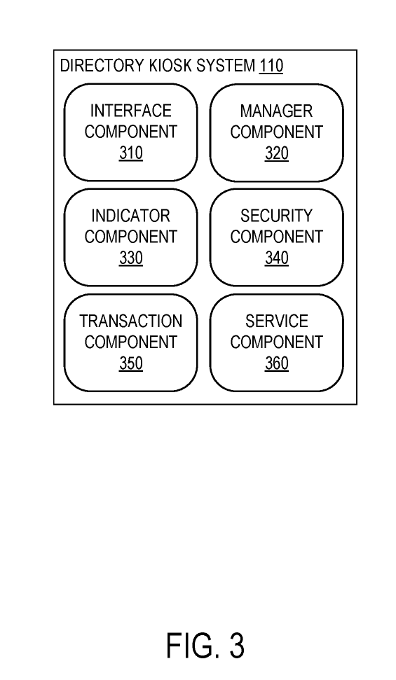

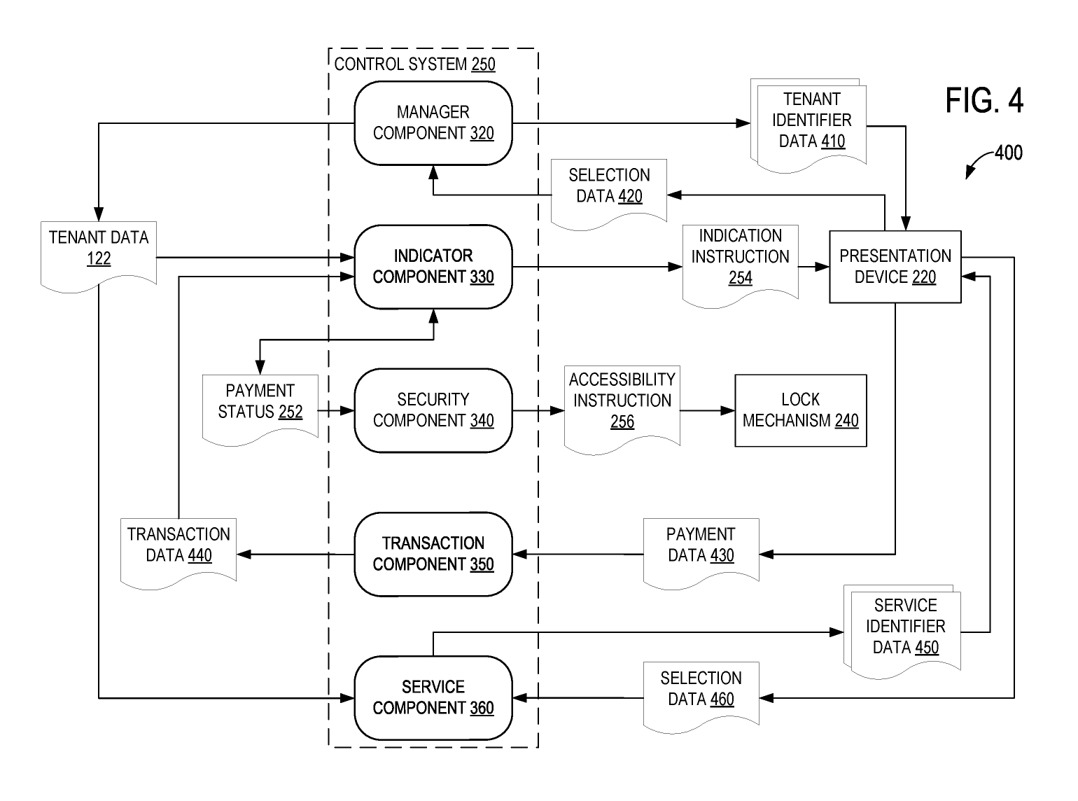

FIG. 3 is a block diagram illustrating a directory kiosk system 110 including an interface component 310, a manager component 320, an indicator component 330, a security component 340, a transaction component 350, and/or a service component 360. FIG. 4 is a block diagram illustrating an example directory kiosk system environment 400 for managing one or more tenant accounts utilizing the control system 250.

The interface component 310 (shown in FIG. 3) enables the directory kiosk system 110 to receive data from and/or transmit data to one or more other computing devices (e.g., landlord system 120, merchant system 130, system server 140, client device 150). For example, the interface component 310 may be coupled to the manager component 320, indicator component 330, security component 340, transaction component 350, and/or service component 360 (e.g., via the communication network 160) to facilitate communication between another computing device and the manager component 320, indicator component 330, security component 340, transaction component 350, and/or service component 360. Additionally or alternatively, the interface component 310 may enable the control system 250 to receive data from and/or transmit data to one or more other computing devices within the directory kiosk system 110 (e.g., presentation device 220, lock mechanism 240). In some embodiments, the interface component 310 facilitates communication between the manager component 320, indicator component 330, security component 340, transaction component 350, and/or service component 360.

The manager component 320 allows a first user of the directory kiosk system 110 (e.g., landlord) to aggregate tenant data 122 associated with a plurality of second users (e.g., tenants) into a common system (e.g., directory kiosk system 110) to efficiently manage a plurality of properties and/or tenant accounts associated with the tenants. The tenant data 122 may include, for example, a tenant identifier, a property location, a payment rate (e.g., rent amount), a payment schedule (e.g., due date), an account balance, transaction data, and the like. In some embodiments, the tenant data 122 is analyzed to generate a summary or report including analytic data, which may be transmitted to a presentation device 220 for presentation at or by the presentation device 220.

The manager component 320 allows a second user of the directory kiosk system 110 (e.g., tenant) to access and/or utilize a tenant account. For example, the manager component 320 may transmit tenant identifier data 410 to a presentation device 220 for presentation of one or more tenant identifiers at or by the presentation device 220, and receive selection data 420 associated with a selection of a tenant identifier from the presentation device 220. In some embodiments, the presentation device 220 communicates with a client device 150 (shown in FIG. 1) to allow a user 112 to select a tenant identifier using the client device 150. For example, tenant identifier data 410 may be transmitted to the client device 150, and client data (e.g., selection data 420) may be received from the client device 150.

Based on the selection data 420, the manager component 320 is configured to identify or select a first tenant from the plurality of tenants, and identify tenant data 122 associated with the first tenant for presentation at or by the presentation device 220. In some embodiments, the manager component 320 authenticates a user 112 before presenting the tenant data 122 to the user 112. For example, the manager component 320 may obtain user input (e.g., credential data), and compare the credential data with registered credentials associated with the tenant account to determine whether the user 112 is authorized to access the tenant data 122.

In some embodiments, the indicator component 330 obtains tenant data 122 associated with the first tenant (e.g., payment rate, payment schedule, account balance) and, based on the tenant data 122, determines or generates a payment status 252 associated with the first tenant. The indicator component 330 is configured to generate an indication instruction 254 based on the payment status 252, and transmit the indication instruction 254 to the presentation device 220 for presenting an indication associated with the payment status 252 at or by the presentation device 220. For example, the indicator component 330 may determine whether the payment status 252 satisfies one or more predetermined indicator thresholds and, based on whether the predetermined indicator thresholds are satisfied, determine an indication that is indicative of the payment status 252.

If no payment is due for a predetermined time period (e.g., one week), then the indicator component 330 may determine that the payment status 252 satisfies a first predetermined indicator threshold and generate an indication instruction 254 for presenting a first indication (e.g., green light). On the other hand, if there is an outstanding balance and/or a payment is due within the predetermined time period or past due, then the payment status 252 does not satisfy the first predetermined indicator threshold.

If there is no outstanding balance (e.g., zero balance, negative balance) and a payment is due within a predetermined time period but not past due, then the indicator component 330 may determine that the payment status 252 satisfies a second predetermined indicator threshold and generate an indication instruction 254 for presenting a second indication (e.g., yellow light). On the other hand, if there is an outstanding balance and/or a payment is past due, then the indicator component 330 may determine that the payment status 252 does not satisfy the first or second predetermined indicator threshold and generate an indication instruction 254 for presenting a third indication (e.g., red light).

In some embodiments, the security component 340 generates a payment status 252 associated with the first tenant (or obtains the payment status 252 from the indicator component 330) and, based on the payment status 252, determines whether to allow a user 112 to access an area associated with the first tenant (e.g., leased space, mailbox). The security component 340 is configured to generate an accessibility instruction 256 based on the payment status 252, and transmit the accessibility instruction 256 to the lock mechanism 240 for configuring the lock mechanism 240 in accordance with the payment status 252. For example, the security component 340 may determine whether the payment status 252 satisfies a predetermined accessibility threshold and, based on whether the predetermined accessibility threshold is satisfied, determine a configuration for the lock mechanism 240.

If no payment is due or a payment is past due for less than or equal to a predetermined time period (e.g., ninety days), then the security component 340 may determine that the payment status 252 satisfies a predetermined accessibility threshold and generate an accessibility instruction 256 for configuring the lock mechanism 240 in the accessible configuration. On the other hand, if payment is past due for greater than the predetermined time period, then the security component 340 may determine that the payment status 252 does not satisfy the predetermined accessibility threshold and generate an accessibility instruction 256 for configuring the lock mechanism 240 in the restricted configuration. In some embodiments, the security component 340 periodically (e.g., daily) or systematically (e.g., with each use of tenant account or directory kiosk system 110) determines a change to the payment status 252 (e.g., payment of balance, passage of time) and automatically generates an accessibility instruction 256 upon determining that the change has affected a satisfaction of the predetermined accessibility threshold (e.g., outstanding balance has been paid, payment has become past due for the predetermined time period).

The transaction component 350 is configured to allow a user 112 to enter into one or more transactions. For example, the second user of the directory kiosk system 110 (e.g., tenant) may utilize the transaction component 350 to make a payment (e.g., rent payment) to the first user (e.g., landlord). In some embodiments, the transaction component 350 receives payment data 430 (e.g., account data, credential data, transaction amount) associated with a financial transaction from the presentation device 220, generates a request for authorization associated with the financial transaction based on the payment data 430, and transmits the request for authorization to a system server 140 for processing the financial transaction.

Upon receiving disposition data from the system server 140 (e.g., approval or declination of the request for authorization), the system server 140 is configured to generate transaction data 440 associated with the financial transaction, and transmit the transaction data 440 to the indicator component 330 and/or security component 340 for generating an updated or new payment status 252. In some embodiments, the indicator component 330 automatically generates an updated or new indication instruction 254 upon determining that the transaction data 440 has affected a satisfaction of the predetermined indicator threshold. Additionally or alternatively, the security component 340 may automatically generate an updated or new accessibility instruction 256 upon determining that the transaction data 440 has affected a satisfaction of the predetermined accessibility threshold.

The service component 360 allows the second user of the directory kiosk system 110 (e.g., merchant-tenant) to manage one or more merchant services. For example, the second user may add, delete, or modify service data 132 to configure the service component 360 to provide one or more merchant services to a third user of the directory kiosk system 110 (e.g., consumer). In some embodiments, the service component 360 allows the third user to locate the merchant, obtain turn-by-turn directions, contact the merchant, purchase goods and/or services, schedule appointments, and/or obtain customer support at the directory kiosk system 110.

The service component 360 is configured to transmit service identifier data 450 to the presentation device 220 for presentation of one or more service identifiers at or by the presentation device 220, and receive selection data 460 associated with a selection of a service identifier from the presentation device 220. In some embodiments, the presentation device 220 communicates with a client device 150 (shown in FIG. 1) to allow the user to select a service identifier using the client device 150. For example, service identifier data 450 may be transmitted to the client device 150, and client data (e.g., selection data 460) may be received from the client device 150. Based on the selection data 460, the service component 360 is configured to identify or select a first merchant service from the one or more merchant services, and provide the first merchant service to the consumer at the directory kiosk system 110.

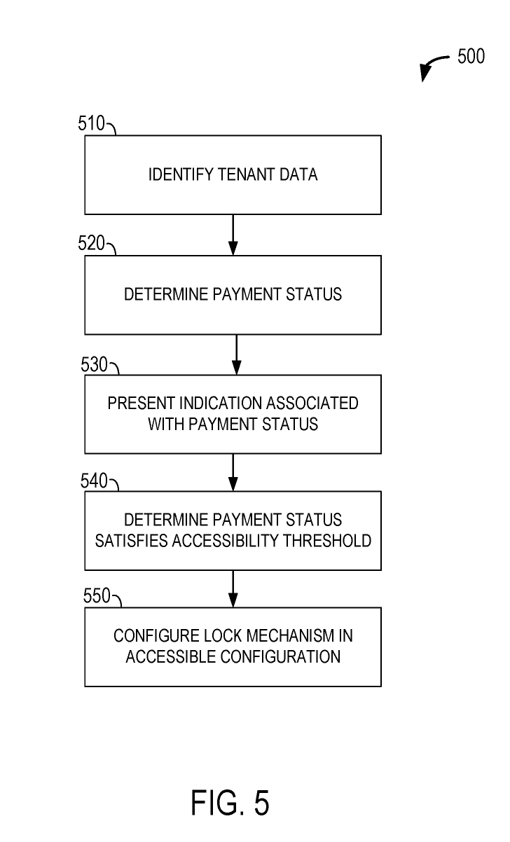

FIG. 5 is a flowchart of an example method 500 for managing a plurality of properties or tenant accounts. A first tenant is selected from a plurality of tenants and, at 510, tenant data 122 associated with the first tenant is identified. Based on the tenant data 122, a payment status 252 associated with the first tenant is determined at 520. An indication associated with the payment status 252 is determined and presented at a presentation device 220 at 530. It is determined at 540 whether the payment status 252 satisfies a predetermined accessibility threshold. On condition that the predetermined accessibility threshold is satisfied, a lock mechanism 240 is selectively configured at 550 in an accessible configuration to allow access to selectively allow access to an area associated with the first tenant in a controlled environment. On the other hand, on condition that the predetermined accessibility threshold is not satisfied, the lock mechanism 240 is selectively configured in a restricted configuration.

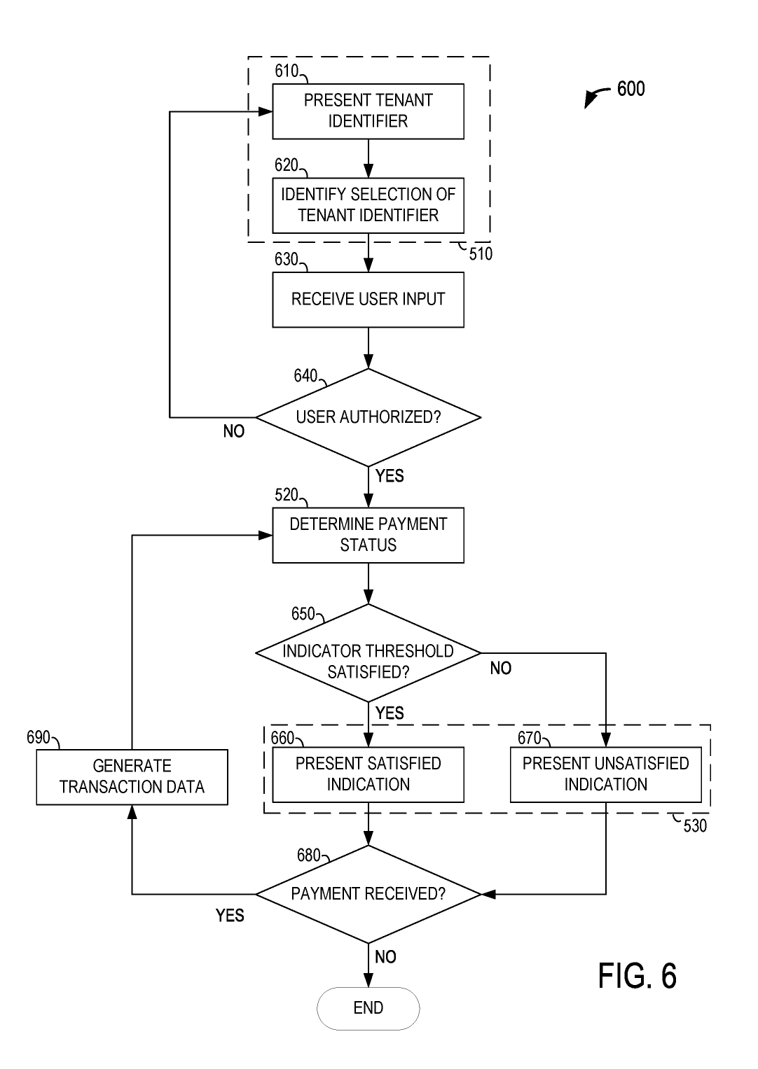

FIG. 6 is a detailed flowchart of a portion of the method 500. For example, selecting a first tenant from a plurality of tenants may include presenting at 610 a tenant identifier at the presentation device 220, and identifying a selection of the tenant identifier at 620. In some embodiments, a plurality of tenant identifiers are presented, and the tenant identifier is selected from the plurality of tenant identifiers. Based on the selection of the tenant identifier, tenant data 122 associated with the selected tenant is identified. In some embodiments, user input (e.g., account data, credential data) is received at 630, and it is determined at 640 whether a user 112 is authorized to access the tenant data 122 associated with the first tenant. If the user 112 is determined to be not authorized to access the tenant data 122, then the user 112 may be prompted to select another tenant identifier and/or provide other credential data.

If the user 112 is determined to be authorized to access the tenant data 122, then a payment status 252 associated with the selected tenant is determined at 520 based on the tenant data 122, and it is determined whether the payment status 252 satisfies one or more indicator thresholds at 650. If an indicator threshold is satisfied, for example, an indication associated with the indicator threshold being satisfied (e.g., green light) is presented at 660. If, on the other hand, the indicator threshold is not satisfied, an indication associated with the indicator threshold not being satisfied (e.g., red light) is presented at 670. In some embodiments, an indication instruction is generated for transmission to a presentation device 220 based on the determination.

In some embodiments, the user 112 may make a payment to affect the payment status 252. For example, it may be determined at 680 whether payment is received. If a payment is received, for example, transaction data 440 associated with the payment may be generated at 690, and a payment status 252 that recognizes or acknowledges the payment may be determined at 520. For example, it may be determined whether to modify the payment status 252 after the payment and, on condition that the payment status 252 is modified, a second indication associated with the payment status may be presented at or by the presentation device 220.

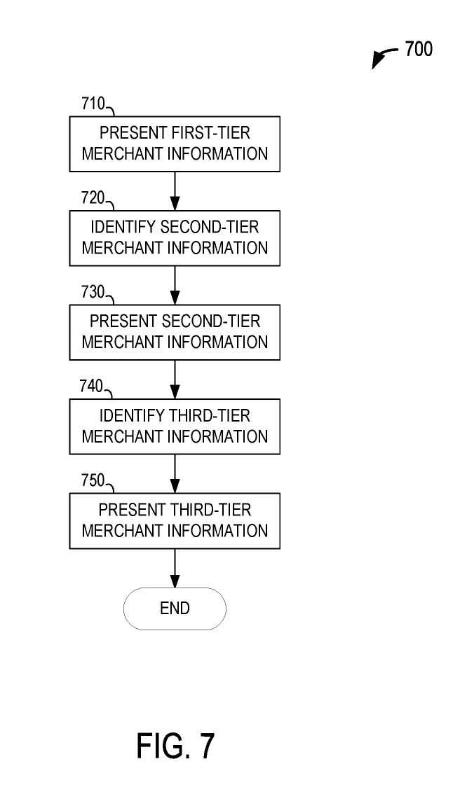

FIG. 7 is a flowchart of an example method 700 for providing one or more merchant services at the directory kiosk system 110. In some embodiments, first-tier merchant information is presented at or by the presentation device 220 at 710. First-tier merchant information may include, for example, one or more merchant identifiers that correspond to one or more merchants. The merchant identifiers may be arranged as a map (e.g., floorplan), a listing (e.g., directory), or in any other format that enables a user 112 to identify and select a desired merchant identifier. Upon identifying a selection of a merchant identifier, a merchant corresponding to the merchant identifier and second-tier merchant information associated with the selected merchant is identified at 720. Second-tier merchant information may include, for example, one or more service identifiers that correspond to one or more merchant services provided by the merchant at the presentation device 220. The second-tier merchant information is presented at or by the presentation device 220 at 730. The service identifiers may be arranged as a listing (e.g., menu) or in any other format that enables a user 112 to identify and select a desired merchant service. Upon identifying a selection of a service identifier, a merchant service corresponding to the service identifier and third-tier merchant information associated with the selected merchant service is identified at 740. Third-tier merchant information may include, for example, service data 132 associated with the selected merchant service. The third-tier merchant information is presented at or by the presentation device 220 at 750.

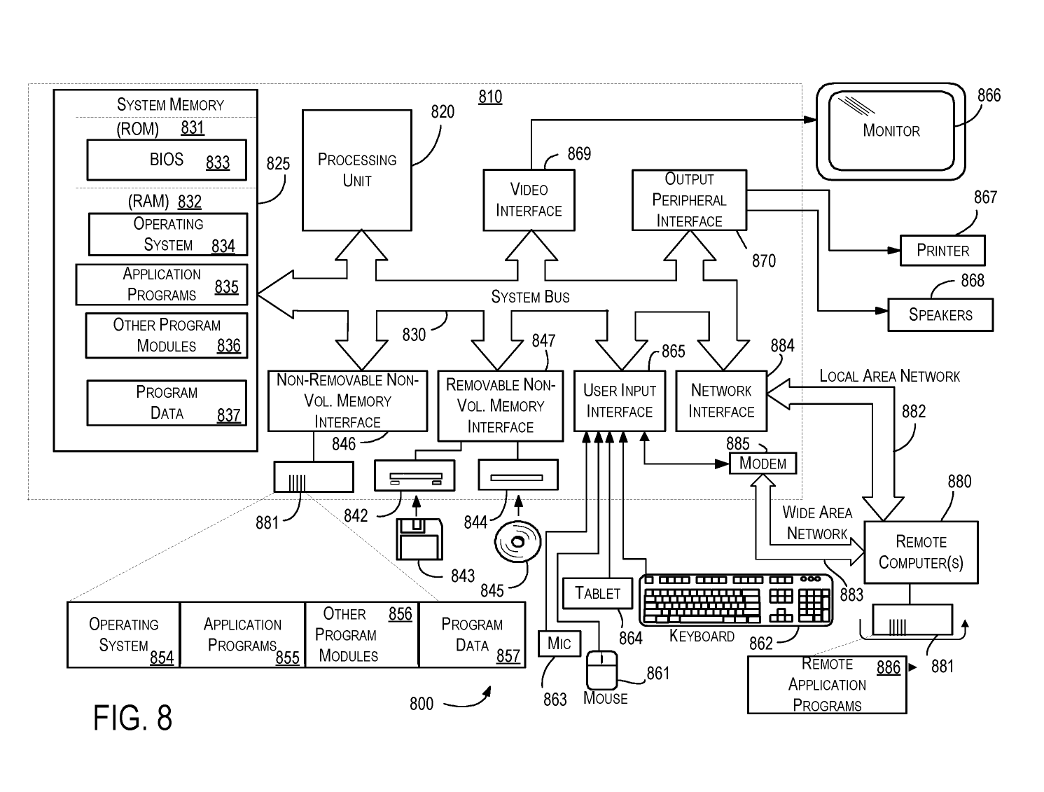

FIG. 8 is a block diagram of an example operating environment 800 that may be used to manage one or more user accounts. The operating environment 800 is only one example of a computing and networking environment and is not intended to suggest any limitation as to the scope of use or functionality of the disclosure. The operating environment 800 should not be interpreted as having any dependency or requirement relating to any one or combination of components illustrated in the example operating environment 800.

The disclosure is operational with numerous other computing and networking environments or configurations. While some examples of the disclosure are illustrated and described herein with reference to the operating environment 800 being associated with or including the directory kiosk system 110, aspects of the disclosure are operable with any computing device (e.g., landlord system 120, merchant system 130, system server 140, client device 150, presentation device 220, lock mechanism 240, control system 250, interface component 310, manager component 320, indicator component 330, security component 340, transaction component 350, service component 360) that executes instructions to implement the operations and functionality associated with the operating environment 800.

For example, the operating environment 800 may include a mobile device, a mobile telephone, a phablet, a tablet, a portable media player, a netbook, a laptop, a desktop computer, a personal computer, a server computer, a computing pad, a kiosk, a tabletop device, an industrial control device, a multiprocessor system, a microprocessor-based system, a set top box, programmable consumer electronics, a network computer, a minicomputer, a mainframe computer, a distributed computing environment that include any of the above systems or devices, and the like. The operating environment 800 may represent a group of processing units or other computing devices. Additionally, any computing device described herein may be configured to perform any operation described herein including one or more operations described herein as being performed by another computing device.

With reference to FIG. 8, an example system for implementing various aspects of the disclosure may include a general purpose computing device in the form of a computer 810. Components of the computer 810 may include, but are not limited to, a processing unit 820 (e.g., processor), a system memory 825 (e.g., computer-readable storage device), and a system bus 830 that couples various system components including the system memory 825 to the processing unit 820. The system bus 830 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 825 includes any quantity of media associated with or accessible by the processing unit 820. For example, the system memory 825 may include computer storage media in the form of volatile and/or nonvolatile memory such as read only memory (ROM) 831 and random access memory (RAM) 832. The ROM 831 may store a basic input/output system 833 (BIOS) that facilitates transferring information between elements within computer 810, such as during start-up. The RAM 832 may contain data and/or program modules that are immediately accessible to and/or presently being operated on by processing unit 820. For example, the system memory 825 may store computer-executable instructions, communication data, authentication data, application data, tenant data 122, service data 132, cardholder account 142, payment status 252, indication instruction 254, accessibility instruction 256, and other data.

The processing unit 820 may be programmed to execute the computer-executable instructions for implementing aspects of the disclosure, such as those illustrated in the figures (e.g., FIGS. 4-7). For example, the system memory 825 may include an interface component 310 (shown in FIG. 3), a manager component 320 (shown in FIGS. 3 and 4), an indicator component 330 (shown in FIGS. 3 and 4), a security component 340 (shown in FIGS. 3 and 4), a transaction component 350 (shown in FIGS. 3 and 4), and/or a service component 360 (shown in FIGS. 3 and 4) for implementing aspects of the disclosure. The processing unit 820 includes any quantity of processing units, and the instructions may be performed by the processing unit 820 or by multiple processors within the operating environment 800 or performed by a processor external to the operating environment 800. By way of example, and not limitation, FIG. 8 illustrates operating system 834, application programs 835, other program modules 836, and program data 837.

Upon programming or execution of these components, the operating environment 800 and/or processing unit 820 is transformed into a special purpose microprocessor or machine. For example, the manager component 320, when executed by the processing unit 820, causes the operating environment 800 to select a tenant; the indicator component 330, when executed by the processing unit 820, causes the operating environment 800 to determine a payment status associated with the tenant based on the tenant data and generate an indication instruction based on the payment status; and a security component 340, when executed by the processing unit 820, causes the operating environment 800 to determine whether the payment status satisfies a predetermined accessibility threshold and generate an accessibility instruction. Although the processing unit 820 is shown separate from the system memory 825, embodiments of the disclosure contemplate that the system memory 825 may be onboard the processing unit 820 such as in some embedded systems.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 842 that reads from or writes to a removable, nonvolatile magnetic disk 843 (e.g., floppy disk, tape cassette), and an optical disk drive 844 that reads from or writes to a removable, nonvolatile optical disk 845 (e.g., compact disc (CD), digital versatile disc (DVD)). Other removable/non-removable, volatile/nonvolatile computer storage media that may be used in the example operating environment include, but are not limited to, flash memory cards, digital video tape, solid state RAM, solid state ROM, and the like. The hard disk drive 841 may be connected to the system bus 830 through a non-removable memory interface such as interface 846, and magnetic disk drive 842 and optical disk drive 844 may be connected to the system bus 830 by a removable memory interface, such as interface 847.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 854, application programs 855, other program modules 856 and program data 857. Note that these components may either be the same as or different from operating system 834, application programs 835, other program modules 836, and program data 837. Operating system 854, application programs 855, other program modules 856, and program data 857 are given different numbers herein to illustrate that, at a minimum, they are different copies.

The computer 810 includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. ROM 831 and RAM 832 are examples of computer storage media. Computer storage media are tangible and mutually exclusive to communication media. Computer storage media for purposes of this disclosure are not signals per se. Example computer storage media includes, but is not limited to, hard disks, flash drives, solid state memory, RAM, ROM, electrically erasable programmable read-only memory (EEPROM), flash memory or other memory technology, CDs, DVDs, or other optical disk storage, magnetic cassettes, magnetic tape, magnetic disk storage or other magnetic storage devices, or any other medium which may be used to store the desired information and which may accessed by the computer 810. Computer storage media are implemented in hardware and exclude carrier waves and propagated signals. Any such computer storage media may be part of computer 810.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

A user may enter commands and information into the computer 810 through one or more input devices, such as a pointing device 861 (e.g., mouse, trackball, touch pad), a keyboard 862, a microphone 863, and/or an electronic digitizer 864 (e.g., tablet). Other input devices not shown in FIG. 8 may include a joystick, a game pad, a controller, a satellite dish, a camera, a scanner, an accelerometer, or the like. These and other input devices may be coupled to the processing unit 820 through a user input interface 865 that is coupled to the system bus 830, but may be connected by other interface and bus structures, such as a parallel port, game port or a universal serial bus (USB).

Information, such as text, images, audio, video, graphics, alerts, and the like, may be presented to a user via one or more presentation devices, such as a monitor 866, a printer 867, and/or a speaker 868. Other presentation devices not shown in FIG. 8 may include a projector, a vibrating component, or the like. These and other presentation devices may be coupled to the processing unit 820 through a video interface 869 (e.g., for a monitor 866 or a projector) and/or an output peripheral interface 870 (e.g., for a printer 867, a speaker 868, and/or a vibration component) that are coupled to the system bus 830, but may be connected by other interface and bus structures, such as a parallel port, game port or a USB. In some embodiments, the presentation device is integrated with an input device configured to receive information from the user (e.g., capacitive touch-screen panel, controller including a vibrating component). Note that the monitor 866 and/or touch screen panel may be physically coupled to a housing in which the computer 810 is incorporated, such as in a tablet-type personal computer.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 882 and one or more wide area networks (WAN) 883, but may also include other networks. Such networking environments are commonplace in offices, enterprise-wide computer networks, intranets and the Internet.

When used in a LAN networking environment, the computer 810 is coupled to the LAN 882 through a network interface or adapter 884. When used in a WAN networking environment, the computer 810 may include a modem 885 or other means for establishing communications over the WAN 883, such as the Internet. The modem 885, which may be internal or external, may be connected to the system bus 830 via the user input interface 865 or other appropriate mechanism. A wireless networking component such as comprising an interface and antenna may be coupled through a device such as an access point or peer computer to a LAN 882 or WAN 883. In a networked environment, program modules depicted relative to the computer 810, or portions thereof, may be stored in the remote memory storage device. By way of example, and not limitation, FIG. 8 illustrates remote application programs 886 as residing on memory storage device 881. It may be appreciated that the network connections shown are examples and other means of establishing a communications link between the computers may be used.

The block diagram of FIG. 8 is merely illustrative of an example system that may be used in connection with one or more examples of the disclosure and is not intended to be limiting in any way. Further, peripherals or components of the computing devices known in the art are not shown, but are operable with aspects of the disclosure. At least a portion of the functionality of the various elements in FIG. 8 may be performed by other elements in FIG. 8, or an entity (e.g., processor, web service, server, applications, computing device, etc.) not shown in FIG. 8.

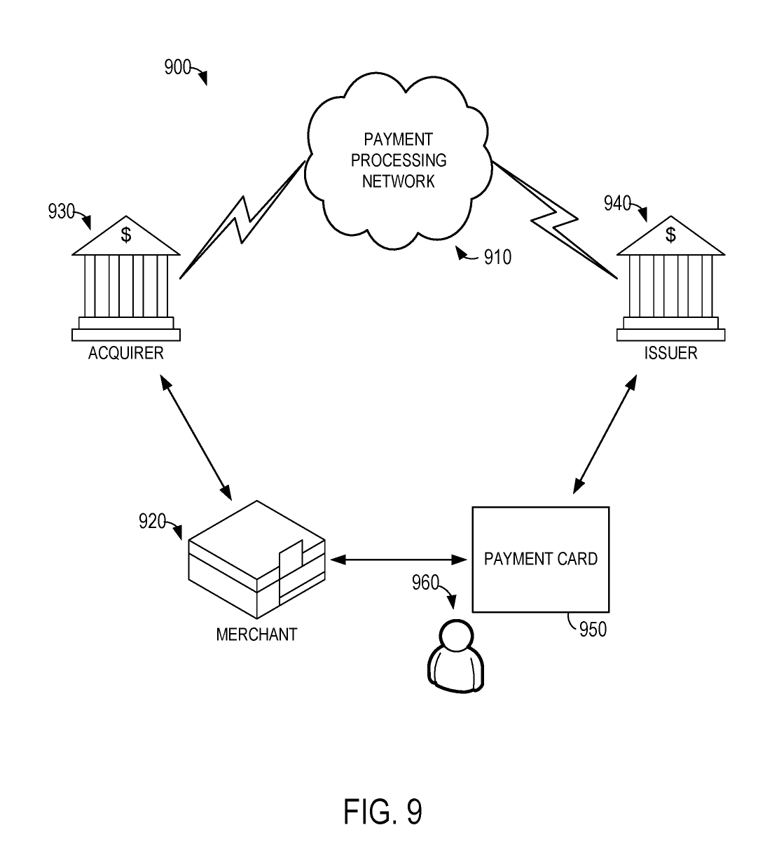

FIG. 9 is a block diagram illustrating an example environment for processing financial transactions. The directory kiosk system 110, for example, may process one or more financial transactions in the environment 900. The environment 900 includes a processing network 910, such as the MASTERCARD® brand payment processing network (MASTERCARD® is a registered trademark of MasterCard International Incorporated located in Purchase, N.Y.). The MASTERCARD® brand payment processing network is a propriety network for exchanging financial transaction data between members of the MASTERCARD® brand payment processing network.

The environment 900 includes one or more merchants 920 (e.g., landlord, merchant) that accept payment via the processing network 910. For example, payment may be accepted at the directory kiosk system 110. To accept payment via the processing network 910, the merchant 920 establishes a financial account with an acquirer 930 that is a member of the processing network 910. The acquirer 930 is a financial institution that maintains a relationship with one or more merchants 920 to enable the merchants 920 to accept payment via the processing network 910. The acquirer 930 may also be known as an acquiring bank, a processing bank, or a merchant bank.

The environment 900 includes one or more issuers 940 that issue or provide payment cards 950 (e.g., credit card, debit card, prepaid card, and the like) or other payment products to one or more cardholders 960 or, more broadly, account holders (“cardholder” and “account holder” may be used interchangeably herein). The issuer 940 is a financial institution that maintains a relationship with one or more cardholders 960 to enable the cardholders 960 to make a payment using the payment card 950 via the processing network 910.

A cardholder 960 uses a payment product, such as a payment card 950, to purchase a good or service from a merchant 920. In some embodiments, the payment card 950 is linked or associated with electronic wallet technology or contactless payment technology, such as a radio frequency identification (RFID)-enabled device, a BLUETOOTH® brand wireless technology-enabled device, a ZIGBEE® brand communication-enabled device, a WI-Fi® brand local area wireless computing network-enabled device, a near field communication (NFC) wireless communication-enabled device, and/or any other device that enables the payment card 950 to purchase a good or service from a merchant 920. (BLUETOOTH® is a registered trademark of Bluetooth Special Interest Group, ZIGBEE® is a registered trademark of the ZigBee Alliance, and WI-FI® is a registered trademark of the Wi-Fi Alliance). The cardholder 960 may use any payment product that is linked or associated with a corresponding financial account maintained by an issuer 940. As described herein, the term “payment card” includes credit cards, debit cards, prepaid cards, digital cards, smart cards, and any other payment product that is linked or associated with a corresponding financial account maintained by an issuer 940. Payment cards 950 may have any shape, size, or configuration that enables the environment 900 to function as described herein.

A cardholder 960 may present the merchant 920 with a payment card 950 to make a payment to the merchant 920 in exchange for a good or service. Alternatively, the cardholder 960 may provide the merchant 920 with account information associated with the payment card 950 without physically presenting the payment card 950 (e.g., for remote financial transactions, including e-commerce transactions, card-not-present transactions, or card-on-file transactions). Account information may include a name of the cardholder 960, an account number, an expiration date, a security code (such as a card verification value (CVV), a card verification code (CVC), and the like), and/or a personal identification number (PIN).

The merchant 920 requests authorization from an acquirer 930 for at least the amount of the purchase. The merchant 920 may request authorization using any financial transaction computing device configured to transmit account information of the cardholder 960 to one or more financial transaction processing computing devices of the acquirer 930. For example, the merchant 920 may request authorization through a point-of-sale (POS) terminal, which reads account information of the cardholder 960 from a microchip or magnetic stripe on the payment card 950, and transmits the cardholder's account information to the one or more financial transaction processing computing devices of the acquirer 930. For another example, the POS terminal reads account information of the cardholder 960 from a device configured to communicate with the POS terminal using contactless payment technology, and transmits the cardholder's account information to one or more financial transaction processing computing devices of the acquirer 930.

Using the processing network 910, the financial transaction processing computing devices of the acquirer 930 communicate with one or more financial transaction processing computing devices of an issuer 940 to determine whether the account information of the cardholder 960 matches or corresponds to the account information of the issuer 940, whether the account is in good standing, and/or whether the purchase is covered by (e.g., less than) a credit line or account balance associated with the financial account. Based on these determinations, the financial transaction processing computing devices of the issuer 940 determine whether to approve or decline the request for authorization from the merchant 920.

If the request for authorization is declined, the merchant 920 is notified as such, and may request authorization from the acquirer 930 for a lesser amount or request an alternative form of payment from the cardholder 960. If the request for authorization is approved, an authorization code is issued to the merchant 920, and the cardholder's available credit line or account balance is decreased. The financial transaction is then settled between the merchant 920, the acquirer 930, the issuer 940, and/or the cardholder 960. Settlement typically includes the acquirer 930 reimbursing the merchant 920 for selling the good or service, and the issuer 940 reimbursing the acquirer 930 for reimbursing the merchant 920. When a credit card is used, the issuer 940 may bill the cardholder 960 to settle a financial account associated with the cardholder 960. When a debit or prepaid card is used, the issuer 940 may automatically withdraw funds from the account.

Although described in connection with an example computing system environment, embodiments of the disclosure are capable of implementation with numerous other general purpose or special purpose computing system environments, configurations, or devices. Embodiments of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, earphones, and the like), network PCs, minicomputers, mainframe computers, distributed computing environments that include any of the above systems or devices, and the like. Such systems or devices may accept input from the cardholder in any way, including from input devices such as a keyboard or pointing device, via gesture input, proximity input (such as by hovering), and/or via voice input.

Embodiments of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

The embodiments illustrated and described herein as well as embodiments not specifically described herein but within the scope of aspects of the disclosure constitute example means for providing a customized or tailored user experience. For example, the elements illustrated in FIG. 1-4, 8, or 9 such as when encoded to perform the operations illustrated in FIGS. 4-7 constitute at least an example means for identifying tenant data (e.g., manager component 320), an example means for determining a payment status (e.g., indicator component 330), an example means for presenting an indication associated with a payment status (e.g., presentation device 220), an example means for determining whether a payment status satisfies a predetermined accessibility threshold (e.g., security component 340), and/or an example means for selectively configuring a lock mechanism (e.g., security component 340).

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In some embodiments, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various embodiments with their associated operations, a person skilled in the art would appreciate that a combination of operations from any number of different embodiments is also within scope of the aspects of the disclosure.

What is claimed is:

1. A directory kiosk system for use in managing a plurality of user accounts, the directory kiosk system comprising:
a housing;
a presentation device coupled to the housing;
a controlled apparatus comprising a lock mechanism selectively configurable between a restricted configuration and an accessible configuration; and
a control system that, upon execution by one or more processors, identifies tenant data associated with a tenant, determines a payment status associated with the tenant based on the tenant data, generates a first indication instruction based on the payment status to present a first indication associated with the payment status at the presentation device, determines whether the payment status satisfies a predetermined accessibility threshold, and, on condition that the predetermined accessibility threshold is satisfied, generates an accessibility instruction to selectively configure the lock mechanism in the accessible configuration.

2. The directory kiosk system of claim 1, wherein the presentation device is configured to present a tenant identifier corresponding to the tenant, and obtain selection data associated with a selection of the tenant identifier, the tenant data identified based on the selection data.

3. The directory kiosk system of claim 1, wherein the control system is configured to obtain client data from a client device, the tenant data identified based on the client data.

4. The directory kiosk system of claim 1, wherein the presentation device is configured to obtain credential data associated with a user of the directory kiosk system, and wherein the control system is configured to determine whether the user is authorized to access the tenant data based on the credential data.

5. The directory kiosk system of claim 1, wherein the control system is configured to determine whether the payment status satisfies one or more predetermined indicator thresholds, the first indication instruction generated based on the determination of whether the payment status satisfies the one or more predetermined indicator thresholds.

6. The directory kiosk system of claim 1, wherein the control system is configured to generate transaction data associated with the tenant, determine whether to modify the payment status based on the transaction data, and, on condition that the payment status is modified, generate a second indication instruction to present a second indication associated with the payment status at the presentation device.

7. The directory kiosk system of claim 1, wherein the presentation device is configured to present a service identifier corresponding to a merchant service associated with the tenant, and obtain selection data associated with a selection of the service identifier, and wherein the control system is configured to provide the merchant service based on the selection data.

8. One or more computer storage media embodied with instructions executable by one or more processors for managing a plurality of user accounts associated with a directory kiosk system, the one or more computer storage media comprising:
a manager component that, upon execution by at least one processor of the one or more processors, selects a tenant from a plurality of tenants, the tenant associated with tenant data;
an indicator component that, upon execution by the at least one processor of the one or more processors, determines a payment status associated with the tenant based on the tenant data, and generates a first indication instruction based on the payment status for presenting, at a presentation device, a first indication associated with the payment status; and
a security component that, upon execution by the at least one processor of the one or more processors, determines whether a predetermined accessibility threshold is satisfied, and generates an accessibility instruction based on whether the predetermined accessibility threshold is satisfied for controlling access to an area associated with the tenant in a controlled environment.

9. The one or more computer storage media of claim 8, wherein the manager component is configured to utilize the presentation device to present a tenant identifier corresponding to the tenant, and obtain selection data associated with a selection of the tenant identifier, the tenant selected based on the selection data.

10. The one or more computer storage media of claim 8 further comprising an interface component configured to establish a communication link with a client device, and wherein the manager component is configured to utilize the communication link to obtain client data from the client device, the tenant selected based on the client data.

11. The one or more computer storage media of claim 8, wherein the manager component is configured to utilize the presentation device to obtain credential data associated with a user of the computing system, and determine whether the user is authorized to access the tenant data based on the credential data.

12. The one or more computer storage media of claim 8, wherein the indicator component is configured to determine whether the payment status satisfies one or more predetermined indicator thresholds, the first indication instruction generated based on the determination of whether the payment status satisfies the one or more predetermined indicator thresholds.

13. The one or more computer storage media of claim 8 further comprising a transaction component configured to generate transaction data associated with the tenant, and wherein the indicator component is configured to determine whether to modify the payment status based on the transaction data, and, on condition that the payment status is modified, generate a second indication instruction for presenting, at the presentation device, a second indication associated with the payment status.

14. The one or more computer storage media of claim 8 further comprising a service component configured to utilize the presentation device to present a service identifier corresponding to a merchant service associated with the tenant, obtain selection data associated with a selection of the service identifier, and provide the merchant service based on the selection data.

15. A computer-implemented method for managing a plurality of user accounts associated with a directory kiosk system, the computer-implemented method comprising:
identifying tenant data associated with a tenant of a plurality of tenants;
based on the tenant data, determining a payment status associated with the tenant;
presenting, at a presentation device, a first indication associated with the payment status;
determining whether the payment status satisfies a predetermined accessibility threshold; and
on condition that the predetermined accessibility threshold is satisfied, configuring a lock mechanism in an accessible configuration to selectively allow access to an area associated with the tenant in a controlled environment.

16. The computer-implemented method of claim 15 further comprising:
presenting, at the presentation device, a tenant identifier corresponding to the tenant; and
receiving, at the presentation device, selection data associated with a selection of the tenant identifier, the tenant data identified based on the selection data.

17. The computer-implemented method of claim 15 further comprising:
receiving, at the presentation device, credential data associated with a user of the directory kiosk system; and
based on the credential data, determining whether the user is authorized to access the tenant data.

18. The computer-implemented method of claim 15 further comprising:
determining whether the payment status satisfies one or more predetermined indicator thresholds; and
generating an indication instruction based on the determination of whether the payment status satisfies the one or more predetermined indicator thresholds, the first indication presented based on the indication instruction.

19. The computer-implemented method of claim 15 further comprising:
generating transaction data associated with the tenant;
based on the transaction data, determining whether to modify the payment status; and
on condition that the payment status is modified, presenting, at the presentation device, a second indication associated with the payment status.

20. The computer-implemented method of claim 15 further comprising:
presenting, at the presentation device, a service identifier corresponding to a merchant service associated with the tenant;
receiving, at the presentation device, selection data associated with a selection of the service identifier; and
based on the selection data, providing the merchant service.
